(19) United States
(12) Patent Application Publication
(10) Pub. No.: US 2004/0246463 A1
(43) Pub. Date: Dec. 9, 2004

(54) Method and apparatus for optical inertial measurement

(76) Inventor: Tomislav F. Milinusic, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/768,964

(22) Filed: Jan. 29, 2004

Related U.S. Application Data
(60) Provisional application No. 60/443,464, filed on Jan. 29, 2003.

(51) Int. Cl. G01P 3/36

(52) U.S. Cl. 356/28.5

(57) ABSTRACT

A method and an apparatus for optical inertial measurement includes a body with an optical head mounted on the body. The optical head has at least one optical element creating an optical path to at least one viewing region. A sensor is in communication with the at least one optical element and adapted to receive images of the at least one viewing region. A processor is provided which is adapted to receive signals from the sensor and perform optical flow motion extraction of the at least one viewing region. The speed and direction of movement of the body and the orientation of the body in terms of pitch, roll and yaw being determined by monitoring the rate and direction of movement of pixel shift within the at least one viewing region, sequentially comparing consecutive images and calculating attitude.

### CROSS-REFERENCE TO RELATED APPLICATION

This application claims the benefit of U.S. Provisional Application No. 60/443,464, filed Jan. 29, 2003.

### FIELD OF THE INVENTION

The present invention is generally related to an optical-based navigation and attitude determination system and method. More particularly, the preferred embodiment of the present invention is directed to an electro-optical means of determining the six Degrees of Freedom (6 DF) of a moving platform with reference to a starting position and attitude.

### BACKGROUND OF THE INVENTION

Current Inertial Measurement Units (IMU) used on airborne platforms have a number of limitations as to accuracy, rate of dynamic and kinematics sensitivity and environmental and jamming disruptions. They are dependent on external input from several sensor technologies to achieve a cohesive solution. For instance, GPS, altimeters, gyrocompass and North heading fluxqate meters are examples of sensors used to maintain data flow to the IMU. Each has its characteristic dependence on the techniques used, with its associated error regime that includes Kalmman filtering. GPS for instance depends on pseudo-random time based trigonometric solution solved in an electronic fashion, while some gyroscopes depend on the Saganac effect and the accuracy of the electronic. Overall, these disparate systems collectively produce results that are less than satisfactory for high-precision geo-location and attitude determination. Further, the sensors can be influenced by external causes such as geomagnetic storms, GPS denial of service and de-calibrated speed sensors.

Current GPS/INS navigation systems suffer from several shortcomings:

1. GPS signal availability (denial of service)

2. Accuracy (meter)

3. Accelerometers and gyroscope drifts

4. Reliance on 5 or more sensors with different measurement sensitivity and update rates for a solution

5. Low update rates Overall: (100-200 Hz), GPS: 1 Hz

6. Complex integration and cabling

7. High cost

### SUMMARY OF THE INVENTION

What is required is a more reliable method and apparatus for optical inertial measurement.

According to the present invention there is provided an apparatus for optical inertial measurement which includes a body with an optical head mounted on the body. The optical head has at least one optical element creating an optical path to at least one viewing region. A sensor is in communication with the at least one optical element and adapted to receive images of the at least one viewing region. A processor is provided which is adapted to receive signals from the sensor and perform optical flow motion extraction of the at least one viewing region. The speed and direction of movement of the body and the orientation of the body in terms of pitch, roll and yaw being determined by monitoring the rate and direction of movement of pixel shift within the at least one viewing region, sequentially comparing consecutive images and calculating attitude.

According to another aspect of the present invention there is provided a method for optical inertial measurement. A first step involves receiving images of at least one viewing region. A second step involves performing optical flow motion extraction of the at least one viewing region, with the speed and direction of movement and orientation in terms of pitch, roll and yaw being determined by monitoring the rate and direction of movement of pixel shift within the at least one viewing region, sequentially comparing consecutive images and calculating attitude.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a theoretical model of the apparatus for optical inertial measurement constructed in accordance with the teachings of the present invention.

FIG. 2 is a perspective view of a housing for the apparatus illustrated in FIG. 1.

FIG. 3 is a perspective view of an aircraft equipped with the apparatus illustrated in FIG. 1.

FIG. 4 is a perspective view of the apparatus illustrated in FIG. 1, with additional star tracking capability.

### DETAILED DESCRIPTION OF THE PREFERRED EMBODIMENT

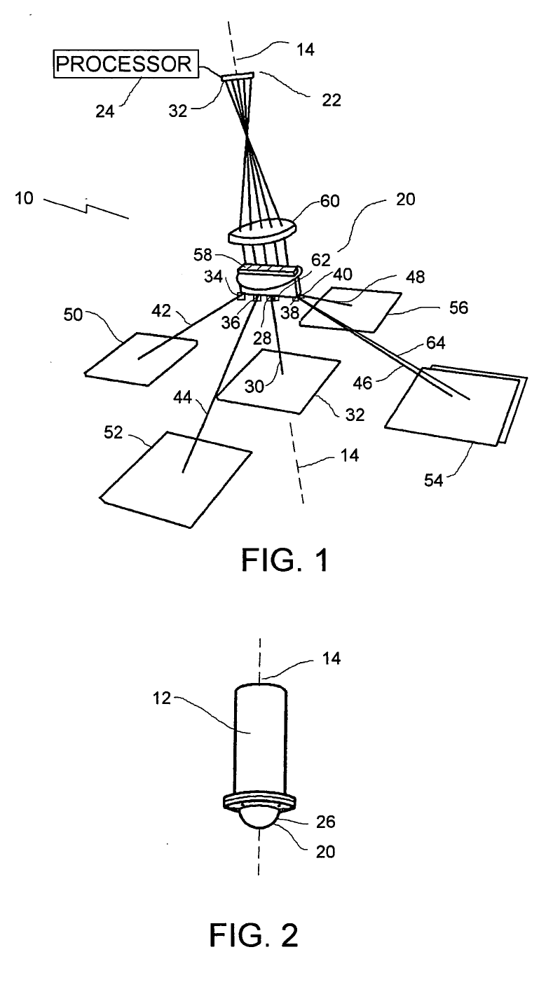

The preferred embodiment apparatus for optical inertial measurement generally identified by reference numeral 10, will now be described with reference to FIGS. 1 through 4.

The preferred embodiment follows a method for optical inertial measurement. This method involves a step of receiving images of a viewing region. A further step is then performed of optical flow motion extraction of the viewing region. As will hereinafter be further described the speed and direction of movement and orientation in terms of pitch, roll and yaw are determined by monitoring the rate and direction of movement of pixel shift within the viewing region, sequentially comparing consecutive images and calculating attitude. It is important to note that the viewing region may be either an earth reference or a celestial reference. The accuracy of the flow motion extraction may be statistically enhanced by using more than one viewing region. The preferred embodiment illustrated uses five viewing regions. Of course, by further increasing the number of viewing regions accuracy can be even further enhanced. Some encouraging results have been obtained through the use of thirteen viewing regions. It is preferred that there be one nadir viewing region with the remainder of the viewing regions symmetrically arranged around the nadir.

Structure and Relationship of Parts

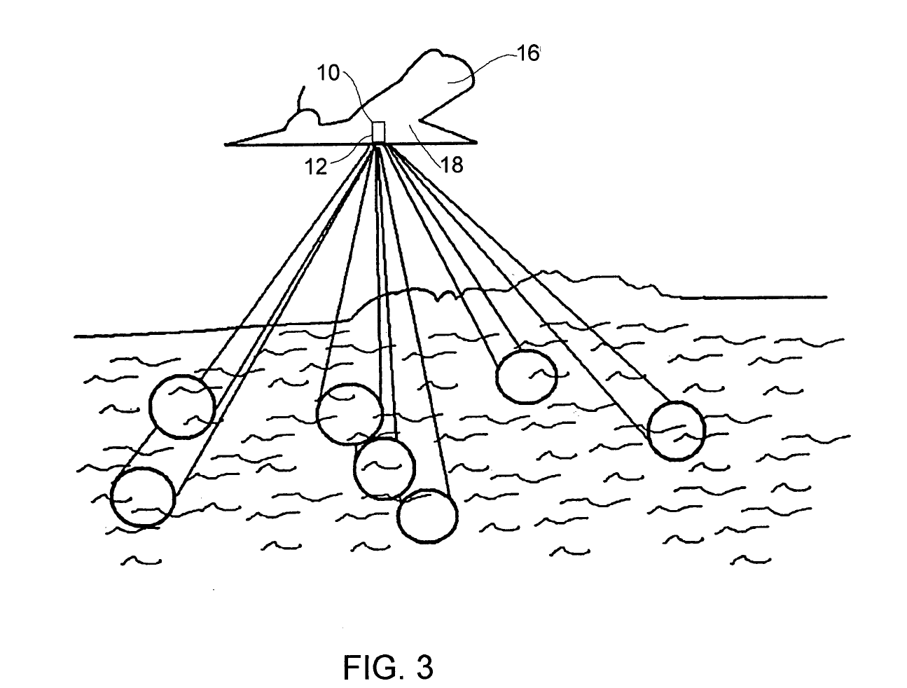

Referring to FIG. 1, apparatus 10 is an all-optical solution that has potentially a three order of magnitude superior performance than traditional IMUs. Unlike other IMUs, it depends on only one input stream, which is a set of imagery, and one conceptual construct, namely: the visual field of view. It's genesis derived from a wide-area reconnaissance sensor that calls for absolute ground referencing accuracy. It is a Dead-Reckoning system with near-absolute positional and kinematics platform attitude measurement with a very high rate of operation. As will hereinafter be described with reference to FIG. 3, it is a viable solution to pose and geo-location of any moving platform. It is capable of monitoring the 3 dimensional positioning, roll, pitch and heading. Referring to FIG. 2, physically, it has a housing body 12 that is tubular in nature. Housing 12 has an axis 14. A basic version (not a special miniature one) is about 3″ in diameter and 12″ in length. Referring to FIG. 3, housing 12 is adapted to be suspended anywhere along a lower portion 16 of an aircraft 18. Although the aircraft illustrated is an airplane, it will be appreciated that the teachings are equally applicable to a helicopter, missile and even bombs. In the case of land or vehicular or dismounted soldier applications, the system description is identical except that stereoscopic measurement is more prevalent and the optical path is slightly modified. Smaller versions are also feasible. Housing body 12 is mounted to aircraft 16 pointing directly downwards, so that axis 14 is in a substantially vertical orientation.

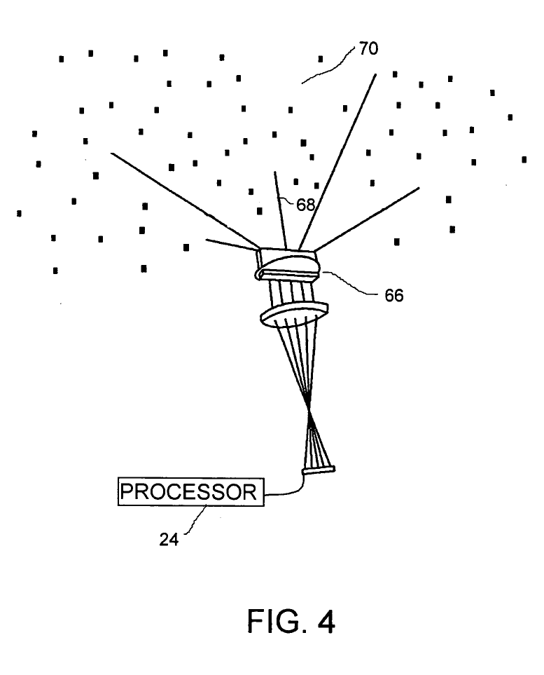

Referring to FIG. 1, apparatus 10 contains three primary components: an optical head generally indicated by reference numeral 20, a sensor 22, and a processor 24 with ultra-fast processing electronics. As will hereinafter be further described with reference to FIG. 4, optionally, for nighttime navigation and if no infrared detectors are used, a star (celestial) tracker is also employed. The technology is preferably all-optical and image processing in concept.

Referring to FIG. 2, optical head 20 is mounted at a remote end 26 of housing body 12. Referring to FIG. 1, optical head 20 contains spatially and goniometric registered optical elements. It serves as the collector of directionally configured sequential imagery needed for the high speed and high accuracy solutions. It has, at its most elemental level, widely separated views of at least five directions pointing in five directions. In the illustrated embodiment, optical head 20 includes a nadir optical element 28 focused along axis 14 to create an optical path 30 to a nadir viewing region 32 and at least four earth reference optical elements 34, 36, 38, 40 arranged spatially around axis 14 in a known spatial relationship. Each of four earth reference optical elements 34, 36, 38, 40 are focused in a different direction and angled downwardly at a known angle relative to axis 14 to create optical viewing paths (42, 44, 46, and 48, respectively) to earth reference viewing regions (50, 52, 54, and 56, respectively). The angle of separation about axis 14 between directions is not necessarily precise. It could be 60 or 45 degrees, for example. What is important is that an exact knowledge of the inter-angle of the views is known, as it will be used in the calculations. The optical path can be done by mirrors or Littrow coated prism producing a 60 degree deflection to the nadir. The idea is that a platform motion in any one angular directions, will instantly affect the field of view of all other ports in a corresponding manner. As well a lateral or forward or backward notion of the platform with or without any angular displacement will also offer a change of view. Such changes of views from all ports are averaged and produce data relative to the 6 DF of the platform.

In the illustrated embodiment, littrow coated prisms 58 have been used. The five (or more as needed) prisms 58 send the parallel rays of the nadir viewing region 32 and the earth reference viewing regions 50, 52, 54 and 56 to a lens 60 in optical head 20 which focuses the images on sensor 22, which is in the form of a one dimensional or two dimensional CCD or other fast detector. Each region is separately analyzed at the rate of the CCD acquisition, which in our case is 1500 times a second. Each region produces 1500 vectors a second of motion extraction. This is done in processor 24 which is an image processing software and hardware unit. An optical flow method for determining the pixel shift and direction to 1/10 of a pixel is used. The sum of such vectors form part of a dead-reckoning solution. In combining the five or more region's optical flow, it is possible to determine the yaw, roll and pitch of the platform to which housing body 12 is attached. The actual equations used are simple quaternion solutions. While this embodiment uses a two dimensional CCD, another uses a linear array of CCD which has advantages over the two dimensional version in that the optical flow calculations are simpler and produce better results.

It is preferred that a secondary optical element 62 be provided to create a secondary optical path 64 at a slight angle relative to the nadir viewing region 32 or any of the other earth reference or celestial reference viewing regions. The system determined for each region nominally consisting of 128×128 pixels in a two dimensional CCD more or less the distance from the platform to the reference earth through a stereo approach whereby for the viewing region 32 secondary optical path 64 is at a slight angle. This makes possible through well established stereo-metric techniques to extract the distance. The calculations of distance permits the dead-reckoning to be made more accurate. It is assumed that the system gets initialized through input of the location and attitude of the housing body 12 at time zero.

Referring to FIG. 1, the detectors used for sensor 22 are two dimensional ultra-high speed visible or infrared capable units that have nominal image acquisition rates of between 1500-4000 images a second. This rate is essentially the rate of the system as a whole with a latency of 4/1000 of a second. In processor 24, a 300 Billion instructions a second, 64 bits SIMD DSP based circuit board containing six specialized processors provides real-time image processing and stereo disparity calculations of the acquired imagery above. The processor provides the six degrees of freedom solution and dead-reckoning equations. This input then is fed into the normal navigation solution computer as if it came from the traditional IMU. There are no other input into the system except for the initial and occasional mid-course “correction” or verification that derives from direct input of GPS location and a heading sensor. The system is completely jam-proof, except for EMP or when it is completely surrounded by, for example, clouds, fog, or any lack of refernce in all of the fields of view. It is ideally suited for both long-range navigation and terminal navigation as the accuracy provided is near absolute, provided a near-continuous fixed ground reference is available and is imaged at all times from at least one point of view. The only known condition in which the system would degrade temporarily is when flying inside a cloud for a few minutes duration. A mid-course correction would be needed to regain reference. Collectively, over 15,000 image frames calculations are processed every second to resolve the attitude and position solution. Classical stereoscopic calculations assist in providing the real-time solution. As an example, at 21,000 meters, a 1,000 km flight line would produce a three-dimensional positional error of plus or minus 5 meters. Any errors, unlike IMU errors, is not time dependent but distance traveled dependent. It is ideal for terminal operations. This is superior to INS/GPS FOG based systems that blends linear acceleration and angular rate measurements provided by the inertial sensors, with position and velocity measurements of GPS to compute the final solution. Of particular advantage, the apparatus 10 does not exhibit any side way drifts associated with IMU, as such drifts are fully taken into account and documented in the optical motion stream of imagery.

Operation

In operation, processor 24 receives signals from sensor and 22 and performs optical flow motion extraction of the nadir viewing region and each earth reference viewing region individually and collectively. The speed and direction of movement of housing body 12 is determined by monitoring the rate and direction of movement of pixel shift and by a 4 by 4 affine matrix calculation. The orientation of housing body 12 in terms of pitch, roll and yaw is determined by relative comparisons of pixel shift of the nadir viewing region and each of the earth reference viewing regions. The processor sequentially compares consecutive images and calculates attitude.

Star Tracker Variation

Referring to FIG. 4, an optical star tracker (moon, sun) can optionally form part of the system with continuous seconds of arc accuracy using arbitrary region of the sky by comparing it to a star position database. The star tracker itself consist of an additional component an optical assembly with a fast, and sensitive CCD and a relatively wide-angle lens whose geometric distortions are accounted for. The 300 GOPS processor acts on the images to provide star pattern matching, database comparison, image enhancement and finally position and attitude determination in concert with the main IMU. Based upon existing technologies, the accuracy that can be expected are in the 50 milli-rad range or better. Referring to FIG. 4, a secondary optical head 66 is provided to provide an optical path 68 focused upon an arbitrary region of the sky as a celestial reference viewing region 70. Processor 24 determines position by monitoring the rate and direction of movement of pixel shift of celestial reference viewing region 70, sequentially comparing consecutive images and calculating attitude.

Performance Data

Based on simulation and other methods of image and stereoscopic registration, it is predicted that the system will have the following minimum and maximum characteristics for an airborne platform, shown on the following pages.

Panvion Sequential Imaging
Geo-Location System (PSIGLS)

| | | Visible | Visible | Visible | | IR |
|---|---|---|---|---|---|---|
| Detector | Units | High Altitude | low altitude | Land Vehicular | IR Soldier | High Altitude |
| Pixels | pixel | 1024 | 1280 | 1280 | 640 | 640 |
| Size per tap | pixel | 204.8 | 128 | 128 | 128 | 128 |
| Directions possible | number | 5 | 10 | 10 | 5 | 5 |
| Pitch | microns | 10 | 10 | 10 | 10 | 10 |
| Detector linear dimension | mm | 10.24 | | | | |
| Detectors rate | khz | 46 | 46 | 46 | 46 | 46 |
| Distance covered per line rate | cm | 0.241545894 | 0.24154589 | 0.120773 | 0.021135 | 0.36231884 |
| Shutter | frames/sec | 1500 | 1500 | 600 | 60 | 60 |
| Littrow Optics | mm | 12.7 | 12.7 | 5 | 5 | 12.7 |
| Number of active facets | | 5 | 5 | 5 | 5 | 5 |
| Lens Diameter | mm | 63.5 | 63.5 | 25 | 25 | 63.5 |
| Focal length | mm | 150 | 150 | 25 | 25 | 100 |
| F/number | f/no | 2.36 | 2.36 | 1.00 | 1.00 | 1.57 |
| Number of pixels used | | 205 | 256 | 256 | 128 | 128 |
| Resolution at 1000 m per pixel | cm | 6.666666667 | 6.66666667 | 40 | 40 | 10 |
| Angular resolution | mr | 0.066666667 | 0.06666667 | 0.4 | 0.4 | 0.1 |
| Distance to target per pixel | m | 21000 | 21000 | 25 | 10 | 21000 |
| Optical target resolution per pixels | cm | 140 | 140 | 1 | 0.4 | 210 |
| Frame size (field of view) | cm | 28,672 | 17920 | 128 | 51.2 | 26880 |
| Distance covered per pixel | cm | 19.11 | 11.95 | 0.21 | 0.85 | 448.00 |
| Speed | km/h | 400 | 400 | 200 | 35 | 600 |
| Speed | m/s | 111 | 111 | 56 | 10 | 167 |
| Movement of vehicle per frame | cm | 7.4 | 7.4 | 9.3 | 16.2 | 277.8 |
| Oversampling | | 18.9 | 18.9 | 0.108 | 0.024686 | 0.756 |
| Total number of frames processed | frames | 7500.00 | 7500.00 | 3000.00 | 300.00 | 300.00 |
| in 1 second real | | | | | | |
| Overlap rate | times | 3870.7 | 2419.2 | 13.8 | 3.2 | 96.8 |
| Expected error in | pixels | 100000 | 100000 | 1000 | 1000 | 1000 |
| Error in pixel in pixels | no | 0.02583 | 0.04134 | 0.07234 | 0.31648 | 0.01033 |
| Cummulative error per 1 second | cm | 0.11 | 0.11 | 5.56 | 0.97 | 16.67 |
| X, Y, Z Positional error in one hour | m | 4.0 | 4.0 | 200.0 | 35.0 | 600.0 |
| of motion | | | | | | |
| Part per milllion error rate | ppm | 36.00 | 36.00 | 3600.00 | 3600.00 | 3600.00 |
| Best dead reckoning 1% | m | 4000 | 4000 | 2000 | 350 | 6000 |
| Times better | time | 1000 | 1000 | 10 | 10 | 10 |
| Input rate | deg/sec | | | | | |
| Angular measures | mr | 17616 | 6881 | 708 | 162 | 1239 |
| Angular rate per second max | deg/sec | 6342 | 2477 | 255 | 58 | 446 |
| Angular rate per second min | deg/hr | 0.667 | 0.667 | 92 | 21 | 161 |

| | Units | High Altitude | Low Altitude |
|---|---|---|---|
| Aircraft Altitude | meters | 21,000 | 21,000 |
| Aircraft Speed | km/h | 400 | 400 |
| Optical and Sampling resolution | cm | 140 | 140 |
| with oversampling | | | |
| Angular resolution | mrad | 0.066666667 | 0.06666667 |
| Sampling rate | Hz | 1,500 | 1,500 |
| Latency | ms | 1.33 | 1.33 |
| Angular rate per second (max) | deg/sec | 6342 | 2477 |
| Distance error over one hour | m | 4.0 | 4.0 |
| period in x,y,z | | | |
| Part per million error | ppm | 36.00 | 36.00 |
| Total number of frames | frames | 7,500 | 7,500 |
| processed in 1 second | | | |
| Total number of frames | frames | 27,000,000 | 27,000,000 |
| processed in 1 hour | | | |

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. An apparatus for optical inertial measurement, comprising:
a body;
an optical head mounted on the body, the optical head having at least one optical element creating an optical path to at least one viewing region;
a sensor in communication with the at least one optical element and adapted to receive both linear and two dimensional images of the at least one viewing region; and
a processor adapted to receive signals from the sensor and perform optical flow motion extraction of the at least one viewing region, the speed and direction of movement of the body and the orientation of the body in terms of pitch, roll and yaw being determined by monitoring the rate and direction of movement of pixel shift within the at least one viewing region, sequentially comparing consecutive images and calculating attitude.

2. The apparatus as defined in claim 1, wherein there is more than one optical element, each of the more than one optical element being focused in a different direction and angled at a known angle relative to the body.

3. The apparatus as defined in claim 2, wherein the more than one optical element are spatially arranged around the body to create a symmetric layout of optical paths.

4. The apparatus as defined in claim 2, wherein there are at least five optical elements optical elements focused in a different direction and angled at a known angle relative to the body to create an optical viewing path to at least five viewing regions.

5. The apparatus as defined in claim 2, wherein at least one of the more than one optical element is a nadir optical element focused to create an optical path to a nadir viewing region.

6. The apparatus as defined in claim 1, wherein a secondary optical element is provided to create a secondary optical path at a slight angle relative to the viewing region, thereby facilitating stereo-metric calculations to extract a distance measurement.

7. The apparatus as defined in claim 1, wherein the at least one viewing region is an earth reference viewing region.

8. The apparatus as defined in claim 1, wherein the at least one viewing region is a celestial reference viewing region.

9. An apparatus for optical inertial measurement, comprising:
an elongate body having an axis, the body being adapted for mounting with the axis in a substantially vertical orientation;
an optical head mounted on the body, the optical head having at least five earth reference optical elements arranged spatially around the axis in a known spatial relationship, with each of the earth reference five optical elements being focused in a different direction and angled downwardly at a known angle relative to the axis to create an optical viewing path to an earth reference viewing region, one of the five earth reference optical elements being a nadir optical element focused along the axis to create an optical path to an earth reference viewing region of a nadir;
a sensor in communication with each earth reference optical element, the sensor being adapted to receive both linear and two dimensional images of each earth reference viewing region; and
a processor adapted to receive signals from the sensor and perform optical flow motion extraction of each earth reference viewing region individually and collectively, the speed and direction of movement of the body and the orientation of the body in terms of pitch, roll and yaw being determined by monitoring the rate and direction of movement of pixel shift of each of the earth reference viewing regions, sequentially comparing consecutive images and calculating attitude.

10. The apparatus as defined in claim 8, wherein secondary optical elements are provided to create a secondary optical path at a slight angle relative to the earth reference viewing region, thereby facilitating stereo-metric calculations to extract a distance measurement.

11. The apparatus as defined in claim 9, wherein a secondary optical head is provided to provide an optical path focused upon arbitrary regions of the sky as at least one celestial reference viewing region, the processor determining position by monitoring the rate and direction of movement of pixel shift of the at least one celestial reference viewing region, sequentially comparing consecutive images and calculating attitude.

12. A method for optical inertial measurement, comprising:
receiving images of at least one viewing region;
performing optical flow motion extraction of the at least one viewing region, with the speed and direction of movement and orientation in terms of pitch, roll and yaw being determined by monitoring the rate and direction of movement of pixel shift within the at least one viewing region, sequentially comparing consecutive images and calculating attitude.

13. The method as defined in claim 12, there being more than one viewing region to statistically enhance the accuracy of and the flow motion extraction.

14. The method as defined in claim 12, the viewing region being an earth reference.

15. The method as defined in claim 12, the viewing region being a celestial reference.
